(19) United States
(12) Patent Application Publication
(10) Pub. No.: US 2019/0095910 A1
(43) Pub. Date: Mar. 28, 2019

(54) SECURE CRYPTOCURRENCY EXCHANGE

(71) Applicant: Intel Corporation, Santa Clara, CA (US)

(72) Inventor: Mariusz Gumowski, Gdansk (PL)

(73) Assignee: Intel Corporation, Santa Clara, CA (US)

(21) Appl. No.: 15/714,537

(22) Filed: Sep. 25, 2017

(51) Int. Cl. G06Q 20/38

(52) U.S. Cl. CPC G06Q 20/3823; G06Q 20/3825; G06Q 20/383; G06Q 20/3829; G06Q 20/3827

(57) ABSTRACT

An embodiment of a semiconductor package apparatus may include technology to create a first participant enclave, verify a second participant enclave, approve a secure exchange of information between the first participant enclave and the second participant enclave, and exchange information between the first participant and the second participant enclaves if the exchange is approved. Other embodiments are disclosed and claimed.

### TECHNICAL FIELD

Embodiments generally relate to cryptocurrency. More particularly, embodiments relate to a secure cryptocurrency exchange.

### BACKGROUND

Cryptocurrencies may include digital currencies or other digital assets that provide an exchange medium. Cryptography is used to secure the transactions and/or to control the creation of additional units of the currency. Digital currencies are considered to be virtual currencies or alternative currencies. BITCOIN is an example of a decentralized cryptocurrency.

### BRIEF DESCRIPTION OF THE DRAWINGS

The various advantages of the embodiments will become apparent to one skilled in the art by reading the following specification and appended claims, and by referencing the following drawings, in which:

FIG. 1 is a block diagram of an example of an electronic processing system according to an embodiment;

FIG. 2 is a block diagram of an example of a semiconductor package apparatus according to an embodiment;

FIGS. 3A to 3B are flowcharts of an example of a method of securely exchanging information according to an embodiment;

FIG. 4 is a block diagram of an example of secure cryptocurrency exchange apparatus according to an embodiment;

FIG. 5 is a block diagram of an example of a secure cryptocurrency exchange system according to an embodiment;

FIG. 6 is a sequence diagram of an example of a secure cryptocurrency exchange according to an embodiment.

FIG. 7 is a block diagram of an example of a computing device according to an embodiment;

FIG. 8 is a block diagram of an example of a processor according to an embodiment; and

FIG. 9 is a block diagram of an example of a computing system according to an embodiment.

### DESCRIPTION OF EMBODIMENTS

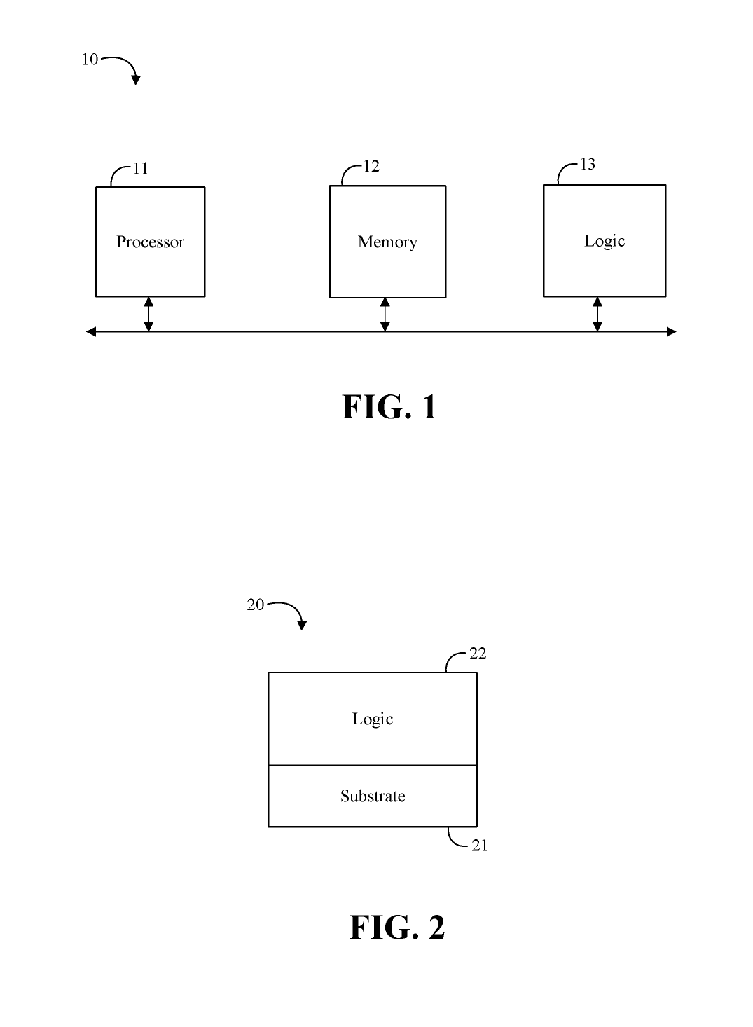

Turning now to FIG. 1, an embodiment of an electronic processing system 10 may include a processor 11, memory 12 communicatively coupled to the processor 11, and logic 13 communicatively coupled to the processor 11 to create a first participant enclave, verify a second participant enclave, approve a secure exchange of information between the first participant enclave and the second participant enclave, and exchange information between the first participant enclave and the second participant enclave if the exchange is approved. In some embodiments, the second participant enclave may be a remote second participant enclave. For example, the logic 13 may be further configured to create the first participant enclave in a secure execution environment, and/or to verify the second participant enclave with a trusted attestation service. In some embodiments, the logic may also be configured to generate a key within the first participant enclave which remains private until both a first participant to the exchange and a second participant to the exchange approve the exchange. For example, the exchanged information may include a cryptocurrency. In some embodiments, the exchanged information may include a first type of cryptocurrency and a second type of cryptocurrency.

Embodiments of each of the above processor 11, memory 12, logic 13, and other system components may be implemented in hardware, software, or any suitable combination thereof. For example, hardware implementations may include configurable logic such as, for example, programmable logic arrays (PLAs), field programmable gate arrays (FPGAs), complex programmable logic devices (CPLDs), or fixed-functionality logic hardware using circuit technology such as, for example, application specific integrated circuit (ASIC), complementary metal oxide semiconductor (CMOS) or transistor-transistor logic (TTL) technology, or any combination thereof.

Alternatively, or additionally, all or portions of these components may be implemented in one or more modules as a set of logic instructions stored in a machine- or computer-readable storage medium such as random access memory (RAM), read only memory (ROM), programmable ROM (PROM), firmware, flash memory, etc., to be executed by a processor or computing device. For example, computer program code to carry out the operations of the components may be written in any combination of one or more operating system (OS) applicable/appropriate programming languages, including an object-oriented programming language such as PYTHON, PERL, JAVA, SMALLTALK, C++, C# or the like and conventional procedural programming languages, such as the “C” programming language or similar programming languages. For example, the memory 12, persistent storage media, or other system memory may store a set of instructions which when executed by the processor 11 cause the system 10 to implement one or more components, features, or aspects of the system 10 (e.g., the logic 13, creating the first participant enclave, verifying the second participant enclave, approving a secure exchange of information between the first participant enclave and the second participant enclave, exchanging information between the first participant enclave and the second participant enclave if the exchange is approved, etc.).

Turning now to FIG. 2, an embodiment of a semiconductor package apparatus 20 may include a substrate 21, and logic 22 coupled to the substrate 21, wherein the logic 22 is at least partly implemented in one or more of configurable logic and fixed-functionality hardware logic. The logic 22 coupled to the substrate 21 may be configured to create a first participant enclave, verify a second participant enclave, approve a secure exchange of information between the first participant enclave and the second participant enclave, and exchange information between the first participant enclave and the second participant enclave if the exchange is approved. For example, the logic 22 may be configured to create the first participant enclave in a secure execution environment, and/or to verify the second participant enclave with a trusted attestation service. In some embodiments, the logic 22 may be further configured to generate a key within the first participant enclave which remains private until both a first participant to the exchange and a second participant to the exchange approve the exchange. For example, the exchanged information may include a cryptocurrency. In some embodiments, the exchanged information may include a first type of cryptocurrency and a second type of cryptocurrency.

Embodiments of logic 22, and other components of the apparatus 20, may be implemented in hardware, software, or any combination thereof including at least a partial implementation in hardware. For example, hardware implementations may include configurable logic such as, for example, PLAs, FPGAs, CPLDs, or fixed-functionality logic hardware using circuit technology such as, for example, ASIC, CMOS, or TTL technology, or any combination thereof. Additionally, portions of these components may be implemented in one or more modules as a set of logic instructions stored in a machine- or computer-readable storage medium such as RAM, ROM, PROM, firmware, flash memory, etc., to be executed by a processor or computing device. For example, computer program code to carry out the operations of the components may be written in any combination of one or more OS applicable/appropriate programming languages, including an object-oriented programming language such as PYTHON, PERL, JAVA, SMALLTALK, C++, C# or the like and conventional procedural programming languages, such as the “C” programming language or similar programming languages.

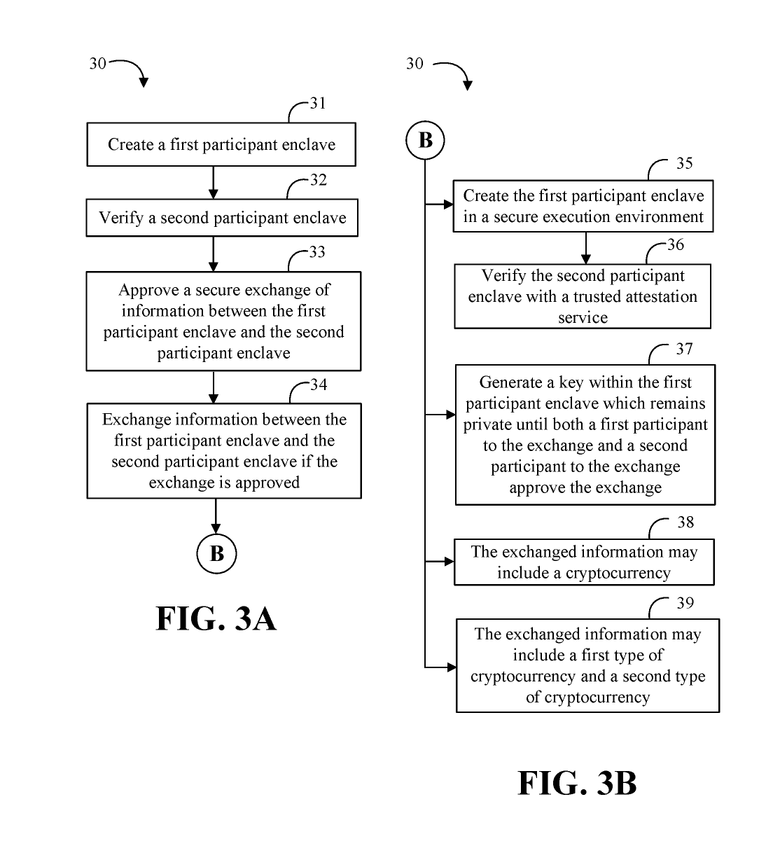

Turning now to FIG. 3, an embodiment of a method 30 of securely exchanging information may include creating a first participant enclave at block 31, verifying a second participant enclave at block 32, approving a secure exchange of information between the first participant enclave and the second participant enclave at block 33, and exchanging information between the first participant enclave and the second participant enclave if the exchange is approved at block 34. For example, the method 30 may also include creating the first participant enclave in a secure execution environment at block 35, and/or verifying the second participant enclave with a trusted attestation service at block 36. Some embodiments of the method 30 may also include generating a key within the first participant enclave which remains private until both a first participant to the exchange and a second participant to the exchange approve the exchange at block 37. For example, the exchanged information may include a cryptocurrency at block 38. In some embodiments, the exchanged information may include a first type of cryptocurrency and a second type of cryptocurrency at block 39.

Embodiments of the method 30 may be implemented in a system, apparatus, computer, device, etc., for example, such as those described herein. More particularly, hardware implementations of the method 30 may include configurable logic such as, for example, PLAs, FPGAs, CPLDs, or in fixed-functionality logic hardware using circuit technology such as, for example, ASIC, CMOS, or TTL technology, or any combination thereof. Alternatively, or additionally, the method 30 may be implemented in one or more modules as a set of logic instructions stored in a machine- or computer-readable storage medium such as RAM, ROM, PROM, firmware, flash memory, etc., to be executed by a processor or computing device. For example, computer program code to carry out the operations of the components may be written in any combination of one or more OS applicable/appropriate programming languages, including an object-oriented programming language such as PYTHON, PERL, JAVA, SMALLTALK, C++, C# or the like and conventional procedural programming languages, such as the “C” programming language or similar programming languages.

For example, the method 30 may be implemented on a computer readable medium as described in connection with Examples 19 to 24 below. Embodiments or portions of the method 30 may be implemented in firmware, applications (e.g., through an application programming interface (API)), or driver software running on an operating system (OS).

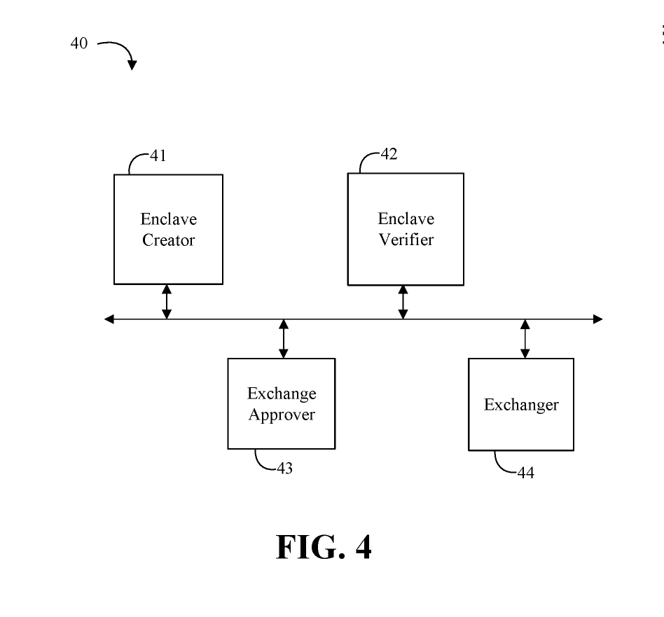

Turning now to FIG. 4, some embodiments may be logically or physically arranged as one or more modules. For example, an embodiment of a secure cryptocurrency exchange apparatus 40 may include an enclave creator 41, an enclave verifier 42, an exchange approver 43, and an exchanger 44. The enclave creator 41 may be configured to create a first participant enclave. The enclave verifier 42 may be configured to verify a second participant enclave. The exchange approver 43 may be configured to approve a secure exchange of information between the first participant enclave and the second participant enclave. The exchanger 44 may be configured to exchange information between the first participant enclave and the second participant enclave if the exchange is approved. For example, the enclave creator 41 may be configured to create the first participant enclave in a secure execution environment. The enclave verifier 42 may be configured to verify the second participant enclave with a trusted attestation service. In some embodiments, the exchanger 44 may be further configured to generate a key within the first participant enclave which remains private until both a first participant to the exchange and a second participant to the exchange approve the exchange.

For example, the exchanged information may include a cryptocurrency. In some embodiments, the exchanged information may include a first type of cryptocurrency and a second type of cryptocurrency. From the buyer's perspective, the first participant enclave may correspond to the buyer's enclave (e.g., created in a secure environment on the buyer's computer) and the second participant enclave may correspond to the seller's enclave (e.g., which needs to be verified by the buyer). From the seller's perspective, the first participant enclave may correspond to the seller's enclave (e.g., created in a secure environment on the seller's computer) and the second participant enclave may correspond to the buyer's enclave (e.g., which needs to be verified by the seller).

Embodiments of the enclave creator 41, the enclave verifier 42, the exchange approver 43, exchanger 44, and other components of the secure cryptocurrency exchange apparatus 40, may be implemented in hardware, software, or any combination thereof including at least a partial implementation in hardware. For example, hardware implementations may include configurable logic such as, for example, PLAs, FPGAs, CPLDs, or fixed-functionality logic hardware using circuit technology such as, for example, ASIC, CMOS, or TTL technology, or any combination thereof. Additionally, portions of these components may be implemented in one or more modules as a set of logic instructions stored in a machine- or computer-readable storage medium such as RAM, ROM, PROM, firmware, flash memory, etc., to be executed by a processor or computing device. For example, computer program code to carry out the operations of the components may be written in any combination of one or more OS applicable/appropriate programming languages, including an object-oriented programming language such as PYTHON, PERL, JAVA, SMALLTALK, C++, C# or the like and conventional procedural programming languages, such as the “C” programming language or similar programming languages.

Some embodiments may advantageously provide a secure cryptocurrency exchange. Cryptocurrencies are becoming more common with hundreds of different types of tradeable cryptocurrencies in hundreds of market exchanges. Because some cryptocurrencies are decentralized, and because some crypto exchanges and trading may rely on unregulated intermediaries holding cryptocurrencies in digital wallets, users are vulnerable to fraud, thefts, hacks and scams which may result in losses of funds. Some embodiments may advantageously provide secure decentralized cryptocurrency exchange between two or more parties. Some embodiments may be applied to a single point exchange vendor (e.g., a website exchange market), a peer-to-peer (P2P) network exchange, and/or a direct cryptocurrency exchange.

Some embodiments may utilize a secure execution environment such as a trusted execution environment (TEE). Non-limiting examples of TEEs include INTEL's TRUSTED EXECUTION TECHNOLOGY, INTEL's SOFTWARE GUARD EXTENSIONS (SGX), AMD's SECURE EXECUTION ENVIROMENT, and ARM's TRUSTZONE. Some embodiments may also utilize a trusted attestation service. Non-limiting examples of a trusted attestation service include SGX remote attestation, and INTEL ATTESTATION SERVICE (IAS). Some embodiments may combine a TEE with a trusted attestation service to provide a secure cryptocurrency exchange which protects both exchange parties (e.g., seller and buyer) from fraud and/or theft. The transaction exchange safety may be guaranteed by attesting to each other (e.g., with the use of the trusted attestation service) that the executed TEE code (e.g., an enclave) is known (e.g., digitally signed), unaltered and is running inside the TEE. Users may transfer their respective cryptocurrencies to an account generated by the enclave(s). Private keys for the cryptocurrencies that are going to be exchanged may be generated inside the TEE enclave and only public keys (e.g., which may correspond to a cryptocurrency address) may be shown to the exchange parties. The public keys may be derived from private keys locally in the enclave(s) to ensure a correct cryptocurrency address is given. When both parties confirm the exchange process completion (e.g., or the exchange is canceled by any party at any time), the respective private keys may be released to the users.

In some cryptocurrency exchanges, funds and cryptocurrencies are deposited in the exchange provider account. This type of exchange may be vulnerable to fraud and/or theft from hackers and/or the exchange provider. In some other cryptocurrency exchanges, an escrow lock may be used together with a multi-signature transaction. When the seller approves the purchase of an item with cryptocurrency, the seller constructs the first part of the escrow lock transaction which contains the seller's security deposit. The buyer then adds the cryptocurrency payment and the buyer's deposit to the escrow lock transaction. Upon receiving delivery of the payment, the seller constructs a transaction which releases the deposits and the purchased item to the respective parties. In the case of seller fraud, the seller will lose their deposit, however the buyer will not only lose their deposit, but will also lose their payment. In the case of buyer fraud, the buyer will lose their deposit, but will gain the item, and the seller will lose both the item and their deposit. Some embodiments may advantageously overcome one or more of the foregoing problems with other cryptocurrency exchanges.

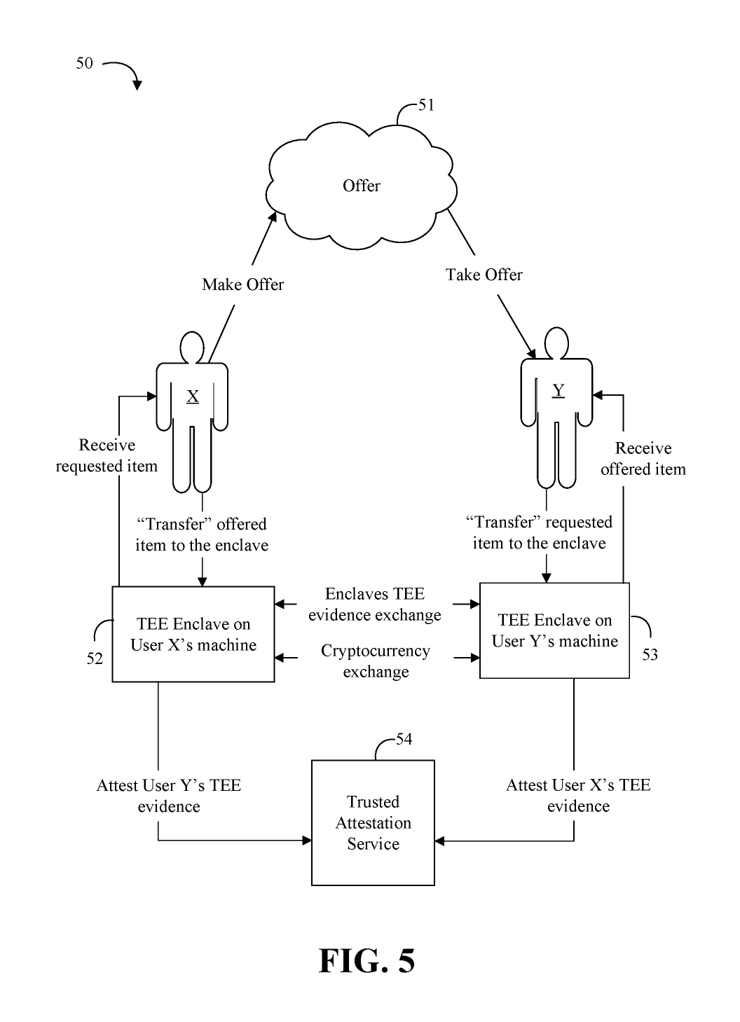

Turning now to FIG. 5, an embodiment of secure cryptocurrency exchange system 50 may include an offer area 51 (e.g., an offer book based on a P2P connection, a server, the cloud, etc.). The system 50 may include a first computing device 52 used by a first user (User X) and a second computing device 53 used by a second user (User Y). For example, the computing devices 52, 53 may include desktop computers, laptop computers, servers, tablets, smartphones, etc. User X may post an offer to buy or sell something (e.g., the offered item) in exchange for something else (e.g., the requested item). For example, the offered item may correspond to one type and amount of cryptocurrency while the requested item may correspond to another type and amount of cryptocurrency. The offer area 51 may facilitate communication and/or negotiation between the two users until an agreement is reached and User Y takes the exchange offer.

Each user may then instantiate their own protected execution environment (e.g., a TEE) on their respective devices 52, 53 with a trusted and digitally signed code base (e.g., an enclave). Each user may then also verify the other user's enclave and/or trusted computing base (TCB) with a trusted attestation service 54. The trusted attestation service 54 may attest that the exchange user is running a known and trusted enclave code in a trusted and encrypted environment. The TEE enclaves may act as guarantors of the exchange. Private keys generated by the enclaves are always inside the respective enclaves and unknown to the users while the exchange is in process, thus protecting each user from fraud and/or theft (e.g., by the other user, hackers, exchange providers, etc.). For example, the private key may be needed for subsequent access to both the offered item and the requested item such that neither User X nor User Y can remove the items from the exchange after the private key is generated.

The TEE enclave may expose only the public part of the key (e.g., which may correspond to a cryptocurrency address) for the user to transfer their respective items. After the item is transferred using the public key, the private key is required to remove the item. The status of the public address may be verified by the other party. For example, each party may confirm that the offered/requested items have been made available for exchange as agreed. Once both parties verify that the offered/requested items are as agreed (e.g., the respective amounts of the exchanged cryptocurrencies are deposited at the cryptocurrency address indicated by the public key), the private keys may be released to the appropriate parties. Each user can also cancel the exchange process at any time without the fear of anyone losing the exchanged cryptocurrency. For example, if the exchange is confirmed by both parties, User X may be provided the private key for the requested item and User Y may receive the private key for the offered item. If either party cancels the exchange (or the exchange otherwise fails), User X may be provided with the private key for the offered item and User Y may be provided with the private key for the requested item.

As compared to other cryptocurrency exchanges, some embodiments may advantageously not require any deposit, may inhibit or prevent fraud on the buyer's side, and/or may inhibit or prevent fraud on seller's side. In addition, or alternatively, some embodiments may not rely on BITCOIN transactions, may be applied to any set of cryptocurrencies, may be anonymous, and/or may be decentralized. Some embodiments may also facilitate payments in different cryptocurrencies than those accepted by a vendor. Some embodiments may advantageously provide a secure way of direct cryptocurrency exchange, where both the seller and buyer assets may be fully protected, and that may be applied to any set of cryptocurrencies (e.g., the exchange is not dependent on any other cryptocurrency).

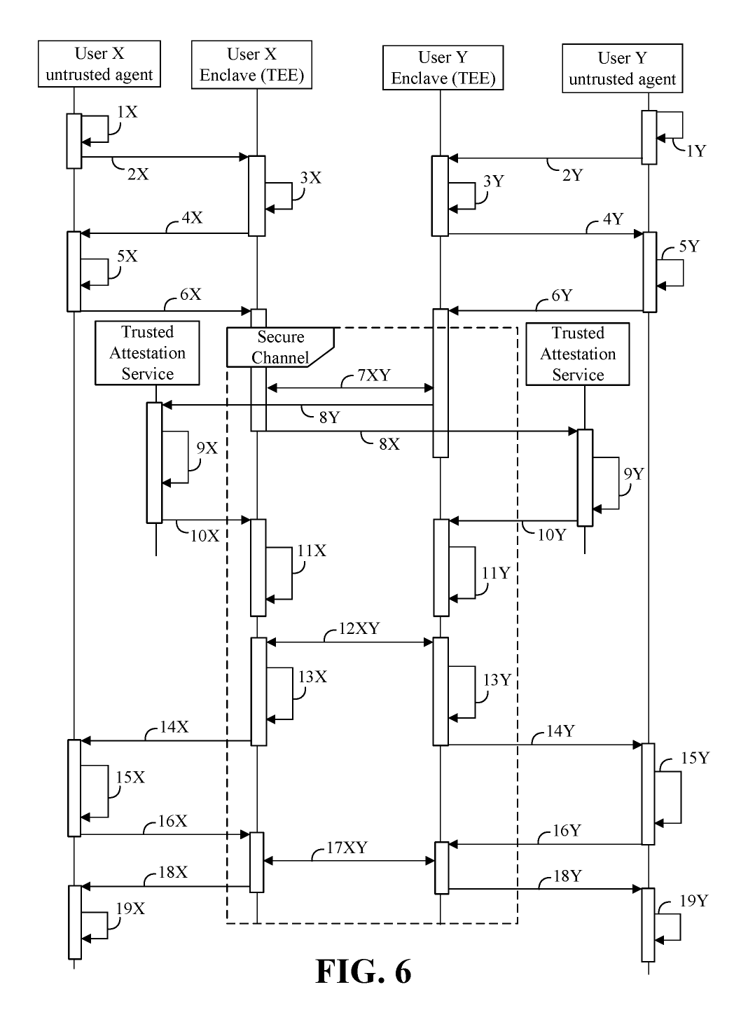

Turning now to FIG. 6, an embodiment of a sequence diagram outlines example cryptocurrency exchange steps. Code to various points of the sequence may be loaded in a TEE (e.g., as the trusted cryptocurrency exchange component). The exchange participants (e.g., User X and User Y) may be matched for the exchange from any suitable type of offer book (e.g., P2P, server, cloud, exchange web service, etc.). User X's computing device may be an untrusted agent from User Y's perspective (and vice versa). At point 1X, User X may verify the digital signature of their own enclave (e.g., the code that will be executed inside User X's TEE enclave). This is to ensure that the enclave code comes from a valid and verified code base or vendor. After the enclave is created and positively verified, the enclave may be loaded into User X's TEE. At point 1Y, User Y may do the same to create User Y's enclave in User Y's TEE.

At points 2X and 2Y, each user may request an address (e.g., an encoded public key with cryptocurrency prefix) for the cryptocurrency they agreed to exchange (e.g., which may be different types of cryptocurrency). At points 3X and 3Y, a private and a public cryptographic key pair may be generated inside the TEE for the respective cryptocurrencies (e.g., cryptocurrency address A for User X's cryptocurrency and cryptocurrency address B for User Y's cryptocurrency). The encoded public keys may basically be respective addresses for the cryptocurrency. At points 4X and 4Y, only the public keys corresponding to the cryptocurrency addresses are returned from the enclaves (A to User X, and B to User Y). The private keys are held inside the respective TEEs.

At points 5X and 5Y, each user transfers the agreed upon offer book amounts of cryptocurrency into the received addresses. After the transfer is complete (e.g., as indicated by the user, automatically determined via notifications, etc.), at points 6X and 6Y the cryptocurrency exchange process may be initiated. At point 7XY, a secure channel may be established between the two TEE enclaves. For example, further communication between the two enclaves may be encrypted (e.g., using secure socket layers (SSL) technology). At points 8X and 8Y, the enclaves exchange verification information. The verification information may be created by the TEE platform and may allow others to verify that the TEE enclave is running on a trusted platform. At points 9X and 9Y, each user may verify the other user's enclave using the provided verification information. For example, the verification information may be securely submitted and may be verified by a remote party such as a trusted attestation service. At points 10X and 10Y, the trusted attestation service may generate an attestation report based on the verification information. At points 11X and 11Y, each user may verify the other user's attestation report, thus ensuring that the exchange parties are both running a valid enclave in a trusted environment. If either party's verification fails, the private keys may be released to the parties to recover their original cryptocurrency (e.g., the private key for cryptocurrency address A to User X, and the private key for cryptocurrency address B to User Y).

If the verification is successful, at point 12XY the two enclaves may now exchange the private keys. At this point the private key for each user's cryptocurrency address remains protected inside the TEE enclaves. At points 13X and 13Y, each enclave may generate a cryptocurrency address for the other user's cryptocurrency by deriving a public key from the received private key. At points 14X and 14Y, the derived cryptocurrency address may be returned to the users. At points 15X and 15Y, the users may verify that the required amount of the cryptocurrency as agreed upon in the exchange offer is deposited at the given address. At points 16X and 16Y, the users may separately approve the cryptocurrency exchange. If either user does not approve the exchange at points 16X or 16Y, the private keys may be released to the parties to recover their original cryptocurrency (e.g., the private key for cryptocurrency address A to User X, and the private key for cryptocurrency address B to User Y).

If both parties approve the cryptocurrency exchange, at point 17XY, the approvals may be exchanged between the two enclaves. At points 18X and 18Y, the exchanged private keys may be released to the users (e.g., the private key for cryptocurrency address B to User X, and the private key for cryptocurrency address A to User Y). At points 19X and 19Y, the users may use their respective private keys to transfer out the exchanged cryptocurrency to a different address (e.g., each user's own respective cryptocurrency wallets).

Some embodiments may also apply to high frequency trading (HFT). For some cryptocurrencies, the cryptocurrency transaction settlement time may not be well suited for HFT. Some embodiments may advantageously exchange information related to trade contracts (e.g., digitally signed trade contracts) via the enclaves rather than the cryptocurrency itself. The trade contract may serve as a promise of a future cryptocurrency exchange and the future exchange may be guaranteed by the TEE enclaves.

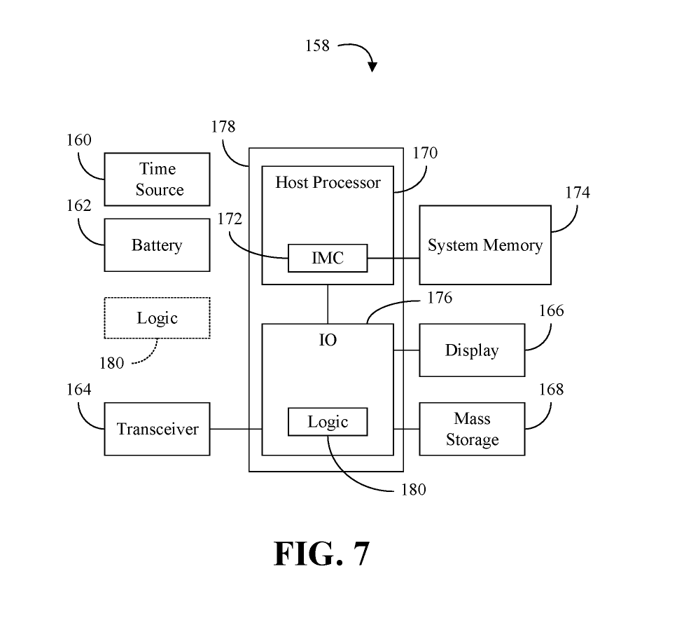

FIG. 7 shows a computing device 158 that may be readily substituted for one or more of the electronic processing system 10 (FIG. 1), the secure cryptocurrency exchange apparatus 40 (FIG. 4), and/or the computing devices 52, 53 (FIG. 5), already discussed. In the illustrated example, the device 158 includes a time source 160 (e.g., crystal oscillator, clock), a battery 162 to supply power to the device 158, a transceiver 164 (e.g., wireless or wired), a display 166 and mass storage 168 (e.g., hard disk drive/HDD, solid state disk/SSD, optical disk, flash memory). The device 158 may also include a host processor 170 (e.g., CPU) having an integrated memory controller (IMC) 172, which may communicate with system memory 174. The system memory 174 may include, for example, dynamic random access memory (DRAM) configured as one or more memory modules such as, for example, dual inline memory modules (DIMMs), small outline DIMMs (SODIMMs), etc. The illustrated device 158 also includes an input output (IO) module 176 implemented together with the processor 170 on a semiconductor die 178 as a system on chip (SoC), wherein the IO module 176 functions as a host device and may communicate with, for example, the display 166, the transceiver 164, the mass storage 168, and so forth. The mass storage 168 may include non-volatile memory (NVM) that stores one or more keys (e.g., MAC generation keys, encryption keys).

The IO module 176 may include logic 180 that causes the semiconductor die 178 to operate as a secure cryptocurrency exchanger such as, for example electronic processing system 10 (FIG. 1), the secure cryptocurrency exchange apparatus 40 (FIG. 4), and/or the computing devices 52, 53 (FIG. 5). Thus, the logic 180 may create a first participant enclave, verify a second participant enclave, approve a secure exchange of information between the first participant enclave and the second participant enclave, and exchange information between the first participant enclave and the second participant enclave if the exchange is approved. For example, the logic 180 may be configured to create the first participant enclave in a secure execution environment, and/or to verify the second participant enclave with a trusted attestation service.

In some embodiments, the logic 180 may be further configured to generate a key within the first participant enclave which remains private until both a first participant to the exchange and a second participant to the exchange approve the exchange. For example, the exchanged information may include a cryptocurrency. In some embodiments, the exchanged information may include a first type of cryptocurrency and a second type of cryptocurrency. In one example, the time source 160 is autonomous/independent from the controller in order to enhance security (e.g., to prevent the controller from tampering with cadence, frequency, latency and/or timestamp data). The logic 180 may also be implemented elsewhere in the device 158.

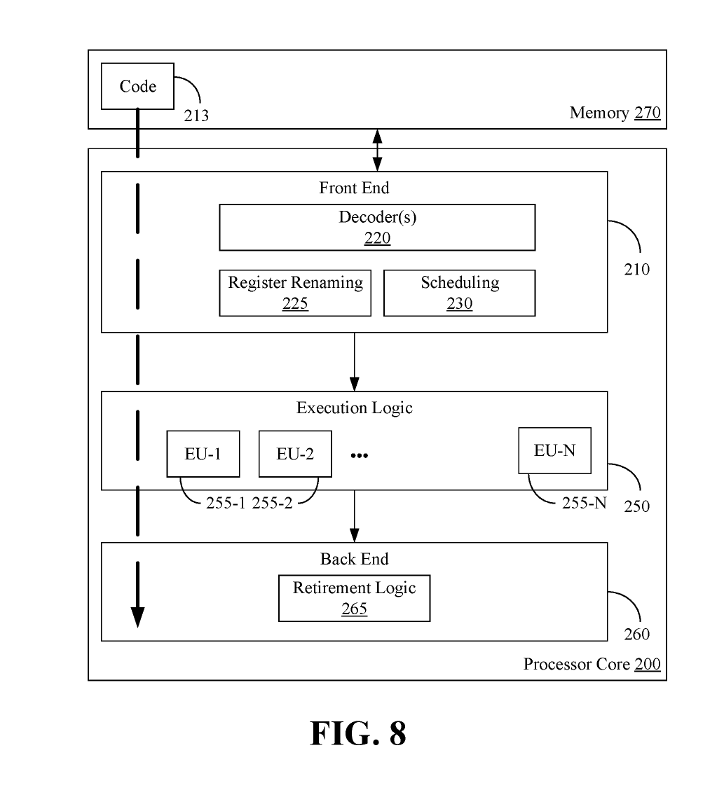

FIG. 8 illustrates a processor core 200 according to one embodiment. The processor core 200 may be the core for any type of processor, such as a micro-processor, an embedded processor, a digital signal processor (DSP), a network processor, or other device to execute code. Although only one processor core 200 is illustrated in FIG. 8, a processing element may alternatively include more than one of the processor core 200 illustrated in FIG. 8. The processor core 200 may be a single-threaded core or, for at least one embodiment, the processor core 200 may be multithreaded in that it may include more than one hardware thread context (or “logical processor”) per core.

FIG. 8 also illustrates a memory 270 coupled to the processor core 200. The memory 270 may be any of a wide variety of memories (including various layers of memory hierarchy) as are known or otherwise available to those of skill in the art. The memory 270 may include one or more code 213 instruction(s) to be executed by the processor core 200, wherein the code 213 may implement the method 30 (FIGS. 3A to 3B) and/or the secure cryptocurrency exchange sequence (FIG. 6), already discussed. The processor core 200 follows a program sequence of instructions indicated by the code 213. Each instruction may enter a front end portion 210 and be processed by one or more decoders 220. The decoder 220 may generate as its output a micro operation such as a fixed width micro operation in a predefined format, or may generate other instructions, microinstructions, or control signals which reflect the original code instruction. The illustrated front end portion 210 also includes register renaming logic 225 and scheduling logic 230, which generally allocate resources and queue the operation corresponding to the convert instruction for execution.

The processor core 200 is shown including execution logic 250 having a set of execution units 255-1 through 255-N. Some embodiments may include a number of execution units dedicated to specific functions or sets of functions. Other embodiments may include only one execution unit or one execution unit that can perform a particular function. The illustrated execution logic 250 performs the operations specified by code instructions.

After completion of execution of the operations specified by the code instructions, back end logic 260 retires the instructions of the code 213. In one embodiment, the processor core 200 allows out of order execution but requires in order retirement of instructions. Retirement logic 265 may take a variety of forms as known to those of skill in the art (e.g., re-order buffers or the like). In this manner, the processor core 200 is transformed during execution of the code 213, at least in terms of the output generated by the decoder, the hardware registers and tables utilized by the register renaming logic 225, and any registers (not shown) modified by the execution logic 250.

Although not illustrated in FIG. 8, a processing element may include other elements on chip with the processor core 200. For example, a processing element may include memory control logic along with the processor core 200. The processing element may include I/O control logic and/or may include I/O control logic integrated with memory control logic. The processing element may also include one or more caches.

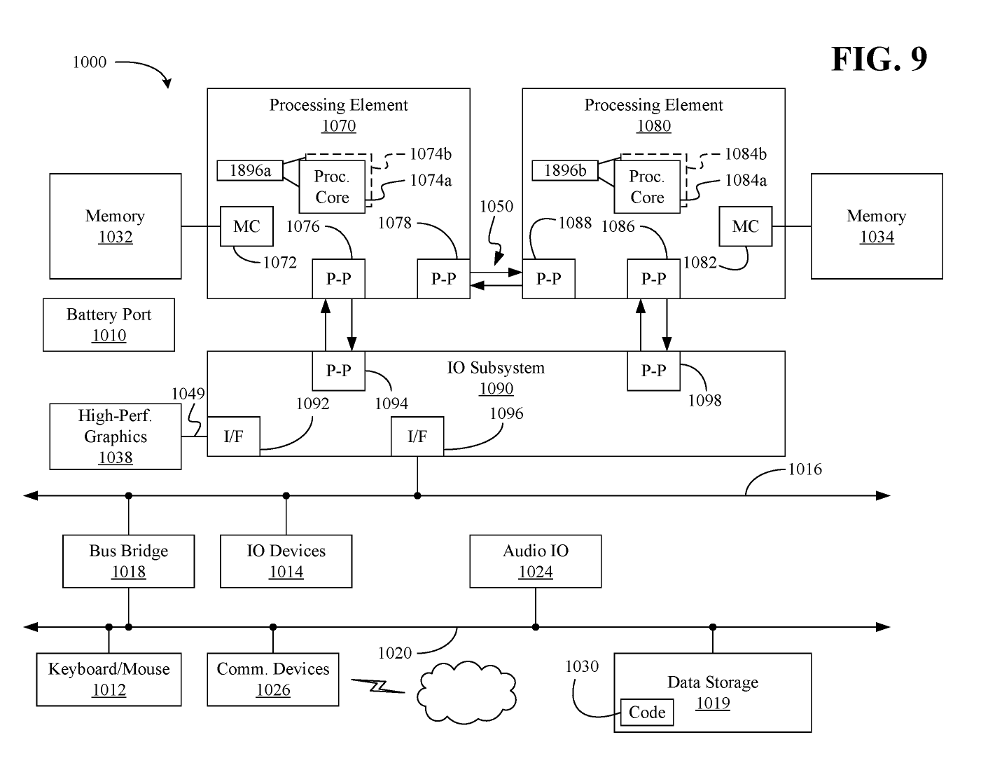

Referring now to FIG. 9, shown is a block diagram of a computing system 1000 embodiment in accordance with an embodiment. Shown in FIG. 9 is a multiprocessor system 1000 that includes a first processing element 1070 and a second processing element 1080. While two processing elements 1070 and 1080 are shown, it is to be understood that an embodiment of the system 1000 may also include only one such processing element.

The system 1000 is illustrated as a point-to-point interconnect system, wherein the first processing element 1070 and the second processing element 1080 are coupled via a point-to-point interconnect 1050. It should be understood that any or all of the interconnects illustrated in FIG. 9 may be implemented as a multi-drop bus rather than point-to-point interconnect.

As shown in FIG. 9, each of processing elements 1070 and 1080 may be multicore processors, including first and second processor cores (i.e., processor cores 1074a and 1074b and processor cores 1084a and 1084b). Such cores 1074a, 1074b, 1084a, 1084b may be configured to execute instruction code in a manner similar to that discussed above in connection with FIG. 8.

Each processing element 1070, 1080 may include at least one shared cache 1896a, 1896b. The shared cache 1896a, 1896b may store data (e.g., instructions) that are utilized by one or more components of the processor, such as the cores 1074a, 1074b and 1084a, 1084b, respectively. For example, the shared cache 1896a, 1896b may locally cache data stored in a memory 1032, 1034 for faster access by components of the processor. In one or more embodiments, the shared cache 1896a, 1896b may include one or more mid-level caches, such as level 2 (L2), level 3 (L3), level 4 (L4), or other levels of cache, a last level cache (LLC), and/or combinations thereof.

While shown with only two processing elements 1070, 1080, it is to be understood that the scope of the embodiments is not so limited. In other embodiments, one or more additional processing elements may be present in a given processor. Alternatively, one or more of processing elements 1070, 1080 may be an element other than a processor, such as an accelerator or a field programmable gate array. For example, additional processing element(s) may include additional processors(s) that are the same as a first processor 1070, additional processor(s) that are heterogeneous or asymmetric to processor a first processor 1070, accelerators (such as, e.g., graphics accelerators or digital signal processing (DSP) units), field programmable gate arrays, or any other processing element. There can be a variety of differences between the processing elements 1070, 1080 in terms of a spectrum of metrics of merit including architectural, micro architectural, thermal, power consumption characteristics, and the like. These differences may effectively manifest themselves as asymmetry and heterogeneity amongst the processing elements 1070, 1080. For at least one embodiment, the various processing elements 1070, 1080 may reside in the same die package.

The first processing element 1070 may further include memory controller logic (MC) 1072 and point-to-point (P-P) interfaces 1076 and 1078. Similarly, the second processing element 1080 may include a MC 1082 and P-P interfaces 1086 and 1088. As shown in FIG. 9, MC's 1072 and 1082 couple the processors to respective memories, namely a memory 1032 and a memory 1034, which may be portions of main memory locally attached to the respective processors. While the MC 1072 and 1082 is illustrated as integrated into the processing elements 1070, 1080, for alternative embodiments the MC logic may be discrete logic outside the processing elements 1070, 1080 rather than integrated therein.

The first processing element 1070 and the second processing element 1080 may be coupled to an I/O subsystem 1090 via P-P interconnects 1076 1086, respectively. As shown in FIG. 9, the I/O subsystem 1090 includes P-P interfaces 1094 and 1098. Furthermore, I/O subsystem 1090 includes an interface 1092 to couple I/O subsystem 1090 with a high performance graphics engine 1038. In one embodiment, bus 1049 may be used to couple the graphics engine 1038 to the I/O subsystem 1090. Alternately, a point-to-point interconnect may couple these components.

In turn, I/O subsystem 1090 may be coupled to a first bus 1016 via an interface 1096. In one embodiment, the first bus 1016 may be a Peripheral Component Interconnect (PCI) bus, or a bus such as a PCI Express bus or another third generation I/O interconnect bus, although the scope of the embodiments is not so limited.

As shown in FIG. 9, various I/O devices 1014 (e.g., biometric scanners, speakers, cameras, sensors) may be coupled to the first bus 1016, along with a bus bridge 1018 which may couple the first bus 1016 to a second bus 1020. In one embodiment, the second bus 1020 may be a low pin count (LPC) bus. Various devices may be coupled to the second bus 1020 including, for example, a keyboard/mouse 1012, communication device(s) 1026, and a data storage unit 1019 such as a disk drive or other mass storage device which may include code 1030, in one embodiment. The illustrated code 1030 may implement the method 30 (FIGS. 3A to 3B) and/or the secure cryptocurrency exchange sequence (FIG. 6), already discussed, and may be similar to the code 213 (FIG. 8), already discussed. Further, an audio I/O 1024 may be coupled to second bus 1020 and a battery port 1010 may supply power to the computing system 1000.

Note that other embodiments are contemplated. For example, instead of the point-to-point architecture of FIG. 9, a system may implement a multi-drop bus or another such communication topology. Also, the elements of FIG. 9 may alternatively be partitioned using more or fewer integrated chips than shown in FIG. 9.

### Additional Notes and Examples

Example 1 may include an electronic processing system, comprising a processor, memory communicatively coupled to the processor, and logic communicatively coupled to the processor to create a first participant enclave, verify a second participant enclave, approve a secure exchange of information between the first participant enclave and the second participant enclave, and exchange information between the first participant enclave and the second participant enclave if the exchange is approved.

Example 2 may include the system of Example 1, wherein the logic is further to create the first participant enclave in a secure execution environment.

Example 3 may include the system of Example 2, wherein the logic is further to verify the second participant enclave with a trusted attestation service.

Example 4 may include the system of Example 3, wherein the logic is further to generate a key within the first participant enclave which remains private until both a first participant to the exchange and a second participant to the exchange approve the exchange.

Example 5 may include the system of any of Examples 1 to 4, wherein the exchanged information includes a cryptocurrency.

Example 6 may include the system of any of Examples 1 to 4, wherein the exchanged information includes a first type of cryptocurrency and a second type of cryptocurrency.

Example 7 may include a semiconductor package apparatus, comprising a substrate, and logic coupled to the substrate, wherein the logic is at least partly implemented in one or more of configurable logic and fixed-functionality hardware logic, the logic coupled to the substrate to create a first participant enclave, verify a second participant enclave, approve a secure exchange of information between the first participant enclave and the second participant enclave, and exchange information between the first participant enclave and the second participant enclave if the exchange is approved.

Example 8 may include the apparatus of Example 7, wherein the logic is further to create the first participant enclave in a secure execution environment.

Example 9 may include the apparatus of Example 8, wherein the logic is further to verify the second participant enclave with a trusted attestation service.

Example 10 may include the apparatus of Example 9, wherein the logic is further to generate a key within the first participant enclave which remains private until both a first participant to the exchange and a second participant to the exchange approve the exchange.

Example 11 may include the apparatus of any of Examples 7 to 10, wherein the exchanged information includes a cryptocurrency.

Example 12 may include the apparatus of any of Examples 7 to 10, wherein the exchanged information includes a first type of cryptocurrency and a second type of cryptocurrency.

Example 13 may include a method of securely exchanging information, comprising creating a first participant enclave, verifying a second participant enclave, approving a secure exchange of information between the first participant enclave and the second participant enclave, and exchanging information between the first participant enclave and the second participant enclave if the exchange is approved.

Example 14 may include the method of Example 13, wherein the logic is further to creating the first participant enclave in a secure execution environment.

Example 15 may include the method of Example 14, wherein the logic is further to verifying the second participant enclave with a trusted attestation service.

Example 16 may include the method of Example 15, wherein the logic is further to generating a key within the first participant enclave which remains private until both a first participant to the exchange and a second participant to the exchange approve the exchange.

Example 17 may include the method of any of Examples 13 to 16, wherein the exchanged information includes a cryptocurrency.

Example 18 may include the method of any of Examples 13 to 16, wherein the exchanged information includes a first type of cryptocurrency and a second type of cryptocurrency.

Example 19 may include at least one computer readable medium, comprising a set of instructions, which when executed by a computing device, cause the computing device to create a first participant enclave, verify a second participant enclave, approve a secure exchange of information between the first participant enclave and the second participant enclave, and exchange information between the first participant enclave and the second participant enclave if the exchange is approved.

Example 20 may include the at least one computer readable medium of Example 19, comprising a further set of instructions, which when executed by the computing device, cause the computing device to create the first participant enclave in a secure execution environment.

Example 21 may include the at least one computer readable medium of Example 20, comprising a further set of instructions, which when executed by the computing device, cause the computing device to verify the second participant enclave with a trusted attestation service.

Example 22 may include the at least one computer readable medium of Example 21, comprising a further set of instructions, which when executed by the computing device, cause the computing device to generate a key within the first participant enclave which remains private until both a first participant to the exchange and a second participant to the exchange approve the exchange.

Example 23 may include the at least one computer readable medium of any of Examples 19 to 22, wherein the exchanged information includes a cryptocurrency.

Example 24 may include the at least one computer readable medium of any of Examples 19 to 22, wherein the exchanged information includes a first type of cryptocurrency and a second type of cryptocurrency.

Example 25 may include a secure information exchange apparatus, comprising means for creating a first participant enclave, means for verifying a second participant enclave, means for approving a secure exchange of information between the first participant enclave and the second participant enclave, and means for exchanging information between the first participant enclave and the second participant enclave if the exchange is approved.

Example 26 may include the apparatus of Example 25, wherein the logic is further to means for creating the first participant enclave in a secure execution environment.

Example 27 may include the apparatus of Example 26, wherein the logic is further to means for verifying the second participant enclave with a trusted attestation service.

Example 28 may include the apparatus of Example 27, wherein the logic is further to means for generating a key within the first participant enclave which remains private until both a first participant to the exchange and a second participant to the exchange approve the exchange.

Example 29 may include the apparatus of any of Examples 25 to 28, wherein the exchanged information includes a cryptocurrency.

Example 30 may include the apparatus of any of Examples 25 to 28, wherein the exchanged information includes a first type of cryptocurrency and a second type of cryptocurrency.

Embodiments are applicable for use with all types of semiconductor integrated circuit (“IC”) chips. Examples of these IC chips include but are not limited to processors, controllers, chipset components, programmable logic arrays (PLAs), memory chips, network chips, systems on chip (SoCs), SSD/NAND controller ASICs, and the like. In addition, in some of the drawings, signal conductor lines are represented with lines. Some may be different, to indicate more constituent signal paths, have a number label, to indicate a number of constituent signal paths, and/or have arrows at one or more ends, to indicate primary information flow direction. This, however, should not be construed in a limiting manner. Rather, such added detail may be used in connection with one or more exemplary embodiments to facilitate easier understanding of a circuit. Any represented signal lines, whether or not having additional information, may actually comprise one or more signals that may travel in multiple directions and may be implemented with any suitable type of signal scheme, e.g., digital or analog lines implemented with differential pairs, optical fiber lines, and/or single-ended lines.

Example sizes/models/values/ranges may have been given, although embodiments are not limited to the same. As manufacturing techniques (e.g., photolithography) mature over time, it is expected that devices of smaller size could be manufactured. In addition, well known power/ground connections to IC chips and other components may or may not be shown within the figures, for simplicity of illustration and discussion, and so as not to obscure certain aspects of the embodiments. Further, arrangements may be shown in block diagram form in order to avoid obscuring embodiments, and also in view of the fact that specifics with respect to implementation of such block diagram arrangements are highly dependent upon the platform within which the embodiment is to be implemented, i.e., such specifics should be well within purview of one skilled in the art. Where specific details (e.g., circuits) are set forth in order to describe example embodiments, it should be apparent to one skilled in the art that embodiments can be practiced without, or with variation of, these specific details. The description is thus to be regarded as illustrative instead of limiting.

The term “coupled” may be used herein to refer to any type of relationship, direct or indirect, between the components in question, and may apply to electrical, mechanical, fluid, optical, electromagnetic, electromechanical or other connections. In addition, the terms “first”, “second”, etc. may be used herein only to facilitate discussion, and carry no particular temporal or chronological significance unless otherwise indicated.

As used in this application and in the claims, a list of items joined by the term “one or more of” may mean any combination of the listed terms. For example, the phrase “one or more of A, B, and C” and the phrase “one or more of A, B, or C” both may mean A; B; C; A and B; A and C; B and C; or A, B and C.

Those skilled in the art will appreciate from the foregoing description that the broad techniques of the embodiments can be implemented in a variety of forms. Therefore, while the embodiments have been described in connection with particular examples thereof, the true scope of the embodiments should not be so limited since other modifications will become apparent to the skilled practitioner upon a study of the drawings, specification, and following claims.

We claim:

1. An electronic processing system, comprising:
a processor;
memory communicatively coupled to the processor; and
logic communicatively coupled to the processor to:
create a first participant enclave,
verify a second participant enclave,
approve a secure exchange of information between the first participant enclave and the second participant enclave, and
exchange information between the first participant enclave and the second participant enclave if the exchange is approved.

2. The system of claim 1, wherein the logic is further to:
create the first participant enclave in a secure execution environment.

3. The system of claim 2, wherein the logic is further to:
verify the second participant enclave with a trusted attestation service.

4. The system of claim 3, wherein the logic is further to:
generate a key within the first participant enclave which remains private until both a first participant to the exchange and a second participant to the exchange approve the exchange.

5. The system of claim 1, wherein the exchanged information includes a cryptocurrency.

6. The system of claim 1, wherein the exchanged information includes a first type of cryptocurrency and a second type of cryptocurrency.

7. A semiconductor package apparatus, comprising:
a substrate; and
logic coupled to the substrate, wherein the logic is at least partly implemented in one or more of configurable logic and fixed-functionality hardware logic, the logic coupled to the substrate to:
create a first participant enclave,
verify a second participant enclave,
approve a secure exchange of information between the first participant enclave and the second participant enclave, and
exchange information between the first participant enclave and the second participant enclave if the exchange is approved.

8. The apparatus of claim 7, wherein the logic is further to:
create the first participant enclave in a secure execution environment.

9. The apparatus of claim 8, wherein the logic is further to:
verify the second participant enclave with a trusted attestation service.

10. The apparatus of claim 9, wherein the logic is further to:
generate a key within the first participant enclave which remains private until both a first participant to the exchange and a second participant to the exchange approve the exchange.

11. The apparatus of claim 7, wherein the exchanged information includes a cryptocurrency.

12. The apparatus of claim 7, wherein the exchanged information includes a first type of cryptocurrency and a second type of cryptocurrency.

13. A method of securely exchanging information, comprising:
creating a first participant enclave;
verifying a second participant enclave;
approving a secure exchange of information between the first participant enclave and the second participant enclave; and
exchanging information between the first participant enclave and the second participant enclave if the exchange is approved.

14. The method of claim 13, wherein the logic is further to:
creating the first participant enclave in a secure execution environment.

15. The method of claim 14, wherein the logic is further to:
verifying the second participant enclave with a trusted attestation service.

16. The method of claim 15, wherein the logic is further to:
generating a key within the first participant enclave which remains private until both a first participant to the exchange and a second participant to the exchange approve the exchange.

17. The method of claim 13, wherein the exchanged information includes a cryptocurrency.

18. The method of claim 13, wherein the exchanged information includes a first type of cryptocurrency and a second type of cryptocurrency.

19. At least one computer readable medium, comprising a set of instructions, which when executed by a computing device, cause the computing device to:
create a first participant enclave;
verify a second participant enclave;
approve a secure exchange of information between the first participant enclave and the second participant enclave; and
exchange information between the first participant enclave and the second participant enclave if the exchange is approved.

20. The at least one computer readable medium of claim 19, comprising a further set of instructions, which when executed by the computing device, cause the computing device to:
create the first participant enclave in a secure execution environment.

21. The at least one computer readable medium of claim 20, comprising a further set of instructions, which when executed by the computing device, cause the computing device to:
verify the second participant enclave with a trusted attestation service.

22. The at least one computer readable medium of claim 21, comprising a further set of instructions, which when executed by the computing device, cause the computing device to:
generate a key within the first participant enclave which remains private until both a first participant to the exchange and a second participant to the exchange approve the exchange.

23. The at least one computer readable medium of claim 19, wherein the exchanged information includes a cryptocurrency.

24. The at least one computer readable medium of claim 19, wherein the exchanged information includes a first type of cryptocurrency and a second type of cryptocurrency.
